(19) United States
(12) Patent Application Publication
(10) Pub. No.: US 2021/0251733 A1
(43) Pub. Date: Aug. 19, 2021

(54) Systems and Methods of Simulating Colors, Opacities and Other Optical Variables in Dental Restoration

(71) Applicant: Aesthetic-Press LLC, Palm Harbor, FL (US)

(72) Inventor: Jorg Muller, Palm Harbor, FL (US)

(21) Appl. No.: 17/177,416

(22) Filed: Feb. 17, 2021

Related U.S. Application Data
(60) Provisional application No. 62/977,606, filed on Feb. 17, 2020.

(51) Int. Cl. A61C 19/10

(52) U.S. Cl. CPC A61C 19/10

(57) ABSTRACT

There are challenges in the prior art of matching new dental work with the color, chroma, translucency and other optical characteristics of existing teeth. The disclosed embodiments overcome shortfalls in the prior art by using an artful combination of stump replicas in convex and/or magnetic attachment to crown or veneer replicas. The disclosed layering and attachment techniques using separate stump and veneer replicas avoid the use of subjective and speculative evaluations by dental professionals in matching proposed dental work to existing dental conditions.

### CROSS-REFERENCE TO RELATED APPLICATIONS

This utility application claims the benefit and priority of U.S. application 62/977,606 filed on Feb. 17, 2020 the contents of which are incorporated herein by reference as if restated.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever. Such trademarks may include “APColor Key Shade Guide” and/or “APVolution.”

### BACKGROUND OF THE INVENTION

### (1) Field of the Invention

The invention generally relates to means and methods of shaping and integrating simulated veneers and stumps to realistically replicate dental work being considered by a patient. More particularly, the invention relates to the creation, assembly and use of sample veneer, crown or other dental finishes integrated with a simulated stump such that a finished sample or color guide assembly can be used to match a patient's existing dental work, resulting in the actual dental work matching the existing teeth of the patient.

### (2) Description of the Related Art

The known related art fails to anticipate or disclose the principles of the present invention.

In the related art, veneer or crown color samples are known but are riddled with flaws. For example, the color guides or color veneer samples of the related art fail to present opacity, layered colors, thickness and other variables that match the optical qualities of the actual materials used in the proposed dental work. Moreover, the related art fails to even consider the optical qualities of the support structure (such as a “stump”) in presenting a color guide or color sample. The color guides or color samples of the related art are optically so far off from the actual dental components used, that the related art requires a dentist or dental technician to use their memory of prior results and/or great skill and imagination to match proposed dental work with the surrounding teeth of a patient.

In the related art, shade guides are often too thick, made of a material that is not representative of the material used in the actual dental work, fail to replicate opacity values and fail to accommodate or even consider stump shade effect influencing the desired final shade. For example, US Published Patent Application US2003/0235799 by Curz discloses various sets of sample shades and translucency guides but fails to disclose, teach or suggest the consideration of stump optical variables.

Thus, there is need in the art for the presently disclosed embodiments.

### BRIEF SUMMARY OF THE INVENTION

The present invention overcomes shortfalls in the related art by presenting an unobvious and unique combination and configuration of methods and components to make and use both simulated veneer samples (the term “veneer” may include a crown or other dental work such as tooth surfacing work) and stumps (the term “stump” may include any support structure such as a remaining stump of a tooth or implanted post) wherein the thickness and concavity of a veneer and stump allow the two components to be set together.

The invention overcomes shortfalls in the related art by using curvilinear configurations of both simulated veneers and stumps such that the observed stump shade effect of a disclosed embodiment matches the stump shade effect and other optical characteristics of the finished dental work.

The disclosed embodiments overcome shortfalls in the known related art by presenting a kit or system comprising a plurality of tooth stump replicas having a convex side and a concave side with the convex side fitting or being complementary to a concave side of a veneer replica. The curved attachment or communication between the disclosed stump and veneer replicas provide a realistic laying of colors and opacities not found in the related art. Moreover, the curved attachment is conducive to the addition of powders and or oils such as Vaseline to increase reflection as needed. The complementary curved configurations of the stump and veneer replicas is also conducive to the disclosed magnetic attachment systems used in both the matting or stable attachment of stump and veneer replicas but also in the use of the disclosed backing board system or storage system or presentation system wherein magnets in the stump and veneer handles are complementary polarity to magnets in the frame of the storage/presentation system.

These and other objects and advantages will be made apparent when considering the following detailed specification when taken in conjunction with the drawings.

### BRIEF DESCRIPTION OF THE DRAWINGS

FIG. 1 depicts a top and side perspective view of stump and veneer replicas in curved and magnetic attachment

FIG. 2 depicts a bottom and side perspective view of stump and veneer replicas

FIG. 3 depicts a storage and presentation rack for low translucent veneer replicas attached to handles

FIG. 4 depicts a storage and presentation rack for medium translucent veneers attached to handles

FIG. 5 depicts a storage and presentation rack for low translucent veneers with extended color values to handles

FIG. 6 depicts a storage and presentation rack for high translucent veneers with bleach shading

FIG. 7 depicts a storage and presentation rack of stumps attached to handles

FIG. 8 depicts the front side of support components of a storage and presentation rack

FIG. 9 depicts a top view of components a storage and presentation rack

FIG. 10 depicts a top view of a storage and presentation rack with handles and tooth replicas attached

FIG. 11 depicts a side view of a storage and presentation rack with handles and tooth replicas attached

FIG. 12 is a perspective view of storage and presentation rack

FIG. 13 is a perspective view of storage and presentation rack with a plurality of tooth replicas and handles attached

FIG. 14 depicts an upper surface of a veneer attached to a handle

FIG. 15 depicts a side view of a veneer attached to a handle

FIG. 16 depicts a bottom view or lower surface view of a veneer attached to a handle

FIG. 17 depicts a veneer and stump in alignment for magnetic attachment

### REFERENCE NUMERALS IN THE DRAWINGS

100 integrated veneer and stump guide in complementary magnetic and curvilinear attachment

200 veneer or veneer replica in general

210 outward convex surface of veneer 200

215 distal edge of veneer 200

220 inward concave surface of veneer 200

260 handle for veneer 200

263 upper surface of veneer handle 260

265 lower surface of veneer handle 260

270 magnet in veneer handle

290 indicia of veneer translucency

295 indicia of veneer color in chroma and value

300 stump or stump replica in general

310 outward convex surface of stump 300

315 distal edge of stump

320 inward concave surface of stump 300

360 handle for stump 300

363 upper surface of stump handle

365 lower surface of stump handle

370 magnet in stump handle

395 indicia of stump color

400 indicia of translucency and chroma value disposed upon a storage rack

410 handle holder disposed upon a storage rack

420 base of a storage rack

430 magnets embedded into a storage rack base 420

500 storage and presentation rack for low translucent veneers attached to veneer handles

510 storage and presentation rack for medium translucent veneers attached to veneer handles

520 storage and rack for low translucent veneers attached to veneer handles with extended color values

530 rack for high translucent veneers with bleach shading

540 rack stumps attached to handles

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Unless the context clearly requires otherwise, throughout the description and the claims, the words “comprise,” “comprising” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “above,” “below,” and words of similar import, when used in this application, shall refer to this application as a whole and not to any particular portions of this application.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform routines having steps in a different order. The teachings of the invention provided herein can be applied to other systems, not only the systems described herein. The various embodiments described herein can be combined to provide further embodiments. These and other changes can be made to the invention in light of the detailed description.

Any and all the above references and U.S. patents and applications are incorporated herein by reference. Aspects of the invention can be modified, if necessary, to employ the systems, functions and concepts of the various patents and applications described above to provide yet further embodiments of the invention.

### Further Shortfalls in the Related Art

Discerning the correct tooth shade or optical variables of a tooth is an age old and everyday challenge for dentists and technicians. Ascertaining the correct values for the optical variables for a tooth may be subject to or impacted by factors such as ambient light sources, time of day, the angle of light reflection, the tooth's surface texture, density of material and the underling stump shade or other framework related to the proposed dental restoration.

Such related art shortfalls include:

1. Shade guides of the related art are sometimes three to four times thicker than the actual crown or veneer restoration. Since color is a result of various layers, shade matching depends on the skillset and artistic work of the technician to recreate the effects, shade, value and chroma. In other words, the technician, using the tools of the related art is forced to use subjective creativity, memory of past results and imagination to recreate a color in a crown which often times is only 0.6 mm-1.2 mm thick vs. the shade guide showing a thickness of up to 4 mm.

2. Shade guides of the related art have a more porous surface as comparted to the finished dental work.

3. Shade guides of the related art are fabricated from material that is different from and/or not representative of the material used or material processed in the finished dental work.

4. Shade guides of the related art fail to provide satisfactory evaluation of a tooth's opacity level.

5. Shade guides of the related art fail to consider or even suggest the consideration of the evaluation of stump shade effect upon the finished dental work.

With the current porcelain systems or color guides of the related art, the technician is not able to see or evaluate how the color of a porcelain restoration will be influenced by the underlying stump shade before starting work. The stump shade can be the most critical aspect in any full porcelain restoration, in either a veneer or a full porcelain crown restoration. Stump shade influences the final color and often has a negative effect on the shade of the crown. This short fall in the related art can be avoided by choosing a certain material opacity or value to block a dark or grey looking stump, as contemplated by the disclosed embodiments. The shade guides of full porcelain systems or the related art offer color indicators which show a porous and unfinished surface. This leads to an unsatisfying evaluation of the true shade and most importantly does not allow different case scenarios with the variety of different stump shades.

The current shades guides in use in the related art, disclose a two dimensional approach to color only and show only chroma and value. In terms of opacity the prior art only is one dimensional only. Shade guides of the related art show a color, for example a VITA A2 only in one level of opacity, whether the patient is 18 or 80 years old. The underlying shade can be an A2, yet the depth and the translucency are completely different, an effect the generic shade guides or the related art are not able to match.

### Further Advantages of the Disclosed Embodiments Over the Related Art

The disclosed embodiments overcome shortfalls in the art by addressing several optical variables not considered or unartfully addressed in the related art.

The disclosed embodiments, sometime referred to as the “AP Color Key Shade Guides” and/or “APVolution” may comprises thicknesses of approximately 0.9 mm at the incisal edge, approximately 1.00 mm in the center of the indicator and approximately 1.3 mm towards the cervical or neck of the tooth. These approximate thicknesses are realistic and thus useful for a technician to match a shade, as they reflect the average thickness of a crown.

The surface of the indicator or disclosed shade guides shows a natural reflection of texture and a shine, which is similar to a natural tooth. The natural reflections of the disclosed embodiments have an demonstrable and positive effect on the final color evaluation.

In addressing stump shade affecting the final dental work, the concavity on the backside of the indicator allows a stump to perfectly fit into the form such as a disclosed sample veneer sample and add to the color effect. The material of which the indicator or disclosed shade guides is made of, is exactly the same material, which the porcelain ingot is made of. The use of exact materials of the finished dental work represents a departure from the related art.

As opposed to the one or two dimensional approach of the related art, the presently disclosed embodiments disclose a multi-dimensional approach that includes:

1. Color in A, B, C and D Chroma

2. Value in 1, 2, 3 and 4

3. Multiple opacity levels, such as LT, MT, HT and HT+

4 the combined use with a in stump shade

Disclosed kit systems may include a storage and presentation racks having magnets with polarity complementary to the polarity of handles with the handles attached to either veneers or stumps. The disclosed storage and presentation racks overcome shortfalls in the prior art by providing a easy visual and physical access to the displayed veneers and stumps, such that the magnets the veneer and stump handles provide both quick attachment to the racks and to its complementary shade component. Thus, the veneer handles have magnets in complementary polarity to both the veneer racks and to the stump handles. And by the same token, the stump handles have magnets in complementary polarity to the stump rack and to the veneer handles.

The disclosed embodiments overcome shortfalls in the art by the use of veneers having distal ends that exceed or surpass the distal ends of the stumps. This configuration of the veneers arching over the stumps creates a more realistic color and opacity representation since in the finished product the veneer will be covering the stump.

The complementary curvilinear relationship and positions of the veneers to the stumps overcomes shortfalls in the art by providing a tooth like curved representation of a stump within a veneer or crown. Thus, the dentist or technician is not disadvantaged by the prior art's penchant for two dimensional models of a flat stump placed under a flat veneer.

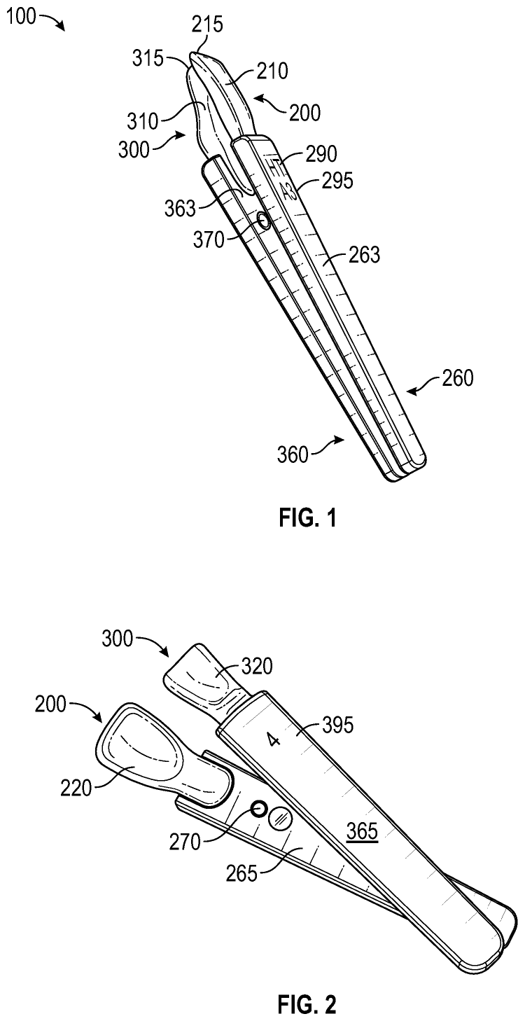

FIG. 1 depicts a perspective view of a disclosed embodiment 100 that may comprise a stump 300 with stump handle 360 and veneer 200 with veneer handle 260 that may be attached or disposed in complementary curvilinear configuration so as to replicate the actual distance and physical relationship between the components as found in the finished dental work.

A disclosed veneer 200 or crown replica may comprise a distal end 215 the exceeds the relative length of a stump distal end 315. A veneer or crown replica 200 may have an outward convex surface 210 and an inward concave surface 220 as shown in FIG. 2. The inward concave surface 220 of the veneer, see FIG. 2, may be complementary to the outward convex surface 310 of the stump as shown in FIG. 1.

The disclosed embodiments and/or components such as those shown in FIG. 1 and FIG. 2 present several advantages over the related art. The concavity of the manually finished and polished porcelain sample veneers or indicators in combination with the stump shades offer an excellent way to select the right porcelain shade and opacity before starting a dental restoration project. The perfectly finished surface texture of the indicator or sample shade surfaces enhances the reflection and visual result comparable to a high-end restoration or finished dental work. The disclosed embodiments increase the efficiency and success rate of any dental restoration including a full porcelain restoration.

FIG. 1 depicts a magnet 370 disposed upon an upper surface 363 of a stump handle 360. FIG. 2 depicts a magnet 270 having complementary polarity and disposed on a lower surface 265 of a veneer handle.

FIG. 1 depicts an upper surface 263 of a veneer handle 260 comprising veneer translucency indica 209 and veneer color and value indicia 295. FIG. 2 depicts the lower surface 365 of a stump handle comprising stump color indicia 395.

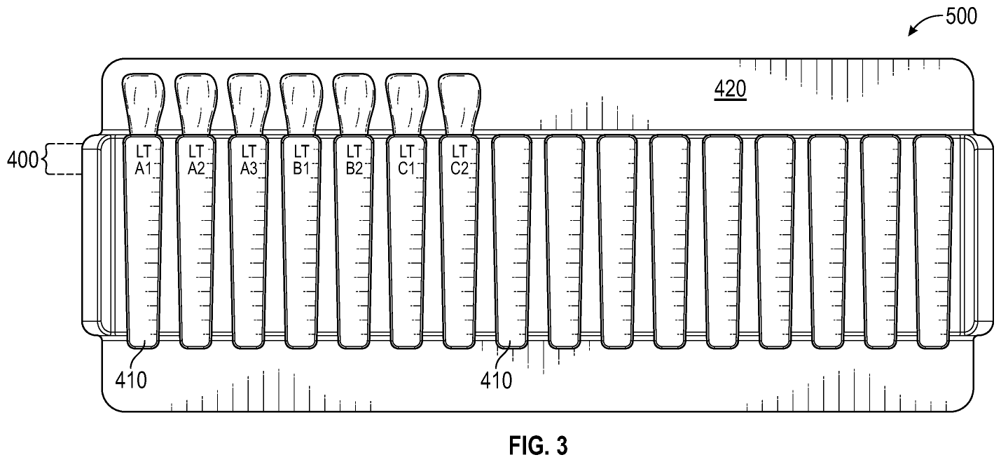

FIG. 3 depicts a rack and/or display assembly 500 that may comprise or have means of attachment for a plurality of low translucent (LT) veneers. A rack may comprise a plurality of handle holders 410 or handles may be attached directly to the base 420 of the storage rack. Holders upon the storage rack may comprise indica 400 of translucency and chroma value.

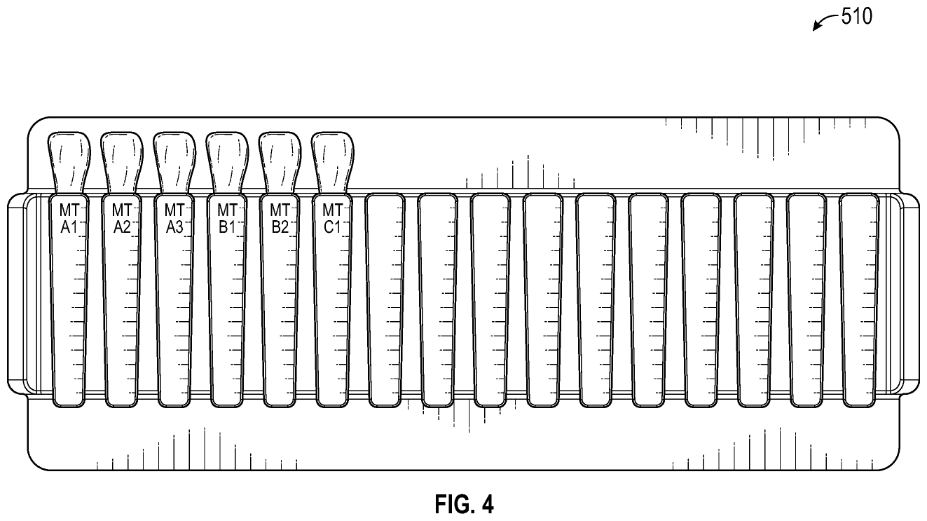

FIG. 4 depicts a rack for medium translucent veneers 510.

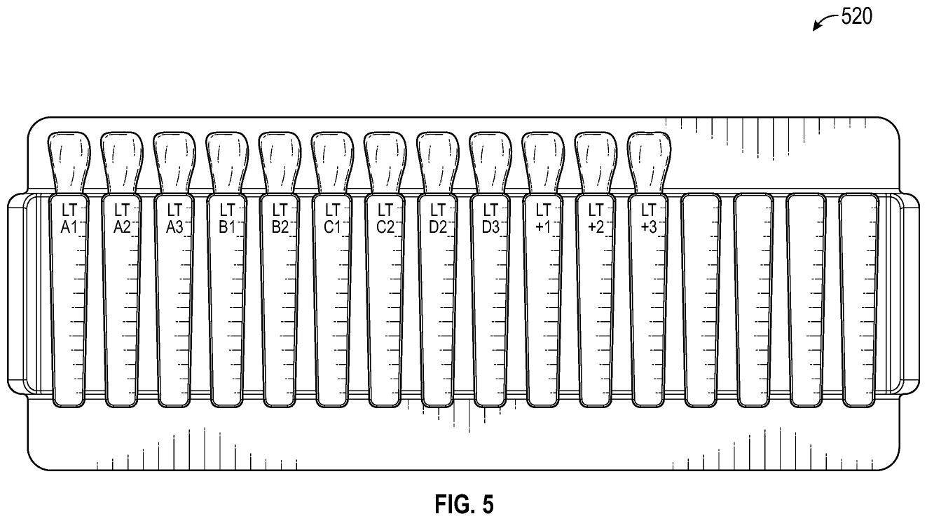

FIG. 5 depicts a rack for low translucent veneers attached to veneer handles with extended color values 520.

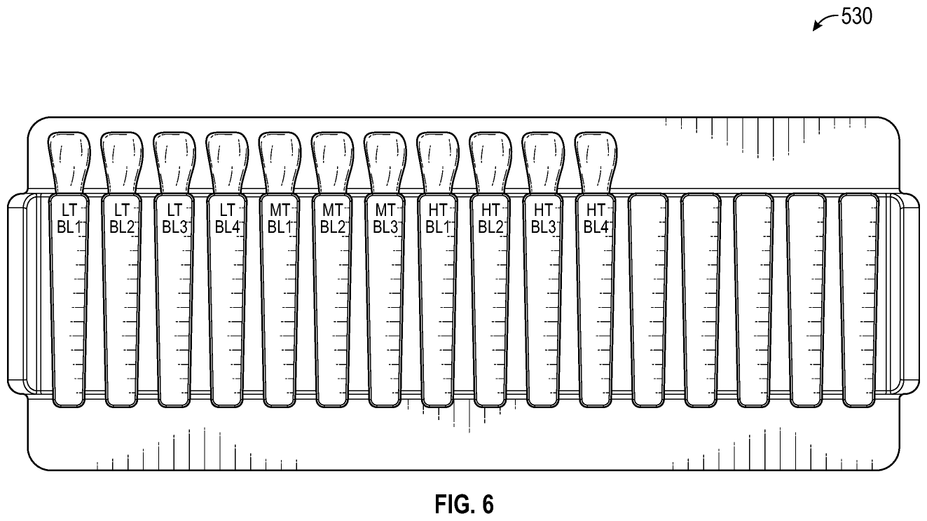

FIG. 6 depicts a rack for high translucent veneers with bleach shading 530.

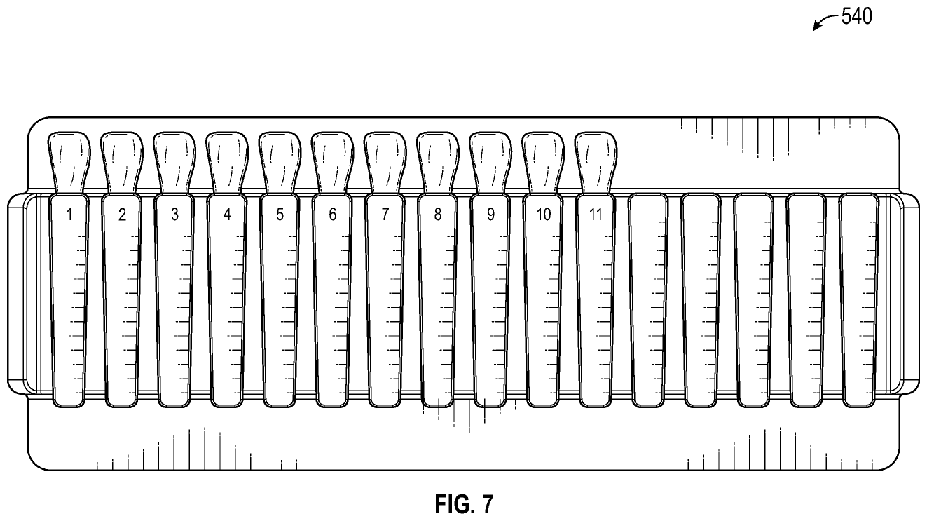

FIG. 7 depicts a rack for stumps attached to handles 540.

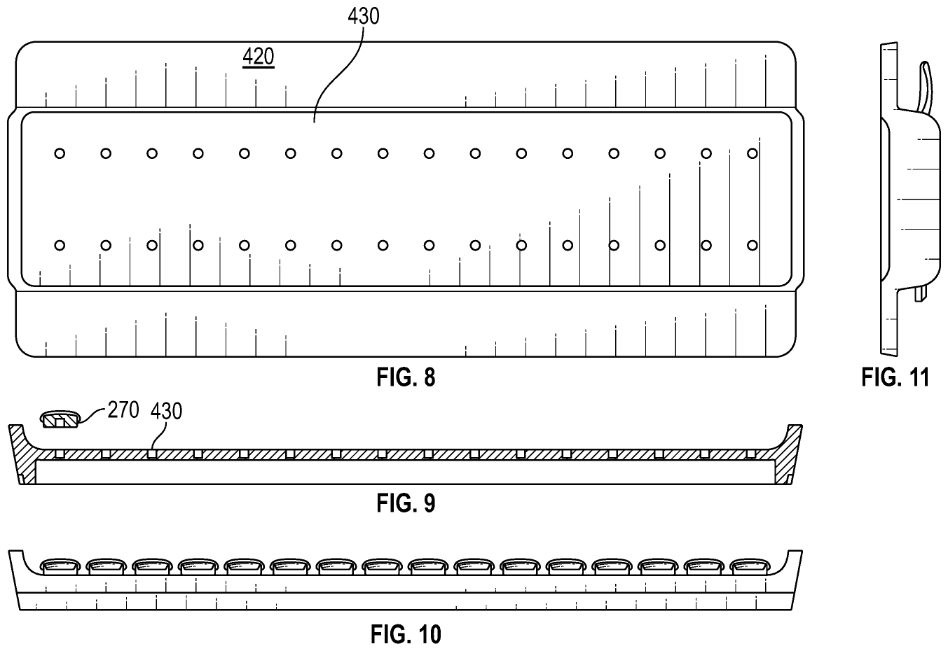

FIG. 8 depicts a frame or base 420 of a storage rack that may comprise a plurality of magnets 430 with the storage rack having magnets of polarity complementary to magnets disposed in a veneer or stump handle.

FIG. 9 depicts a top view of a magnet 270 of a veneer handle in alignment with a rack magnet 430.

FIG. 10 depicts a plurality of handles or handle holders disposed upon the base of a rack.

FIG. 11 depicts a side view of a handle with veneer in magnetic attachment to a rack base.

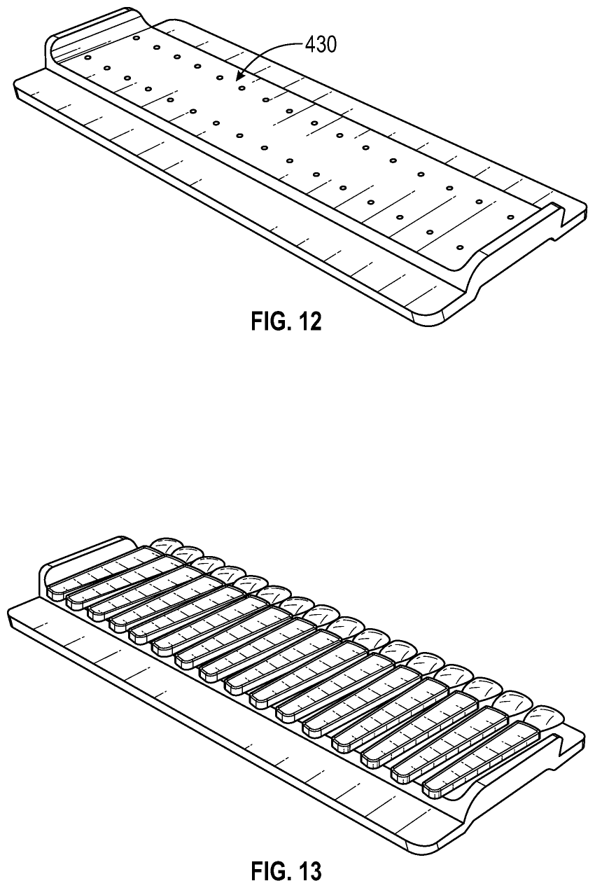

FIG. 12 depicts a perspective view of a rack base with a plurality of magnets 430.

FIG. 13 a perspective view of a rack with a plurality of handles or handle holders.

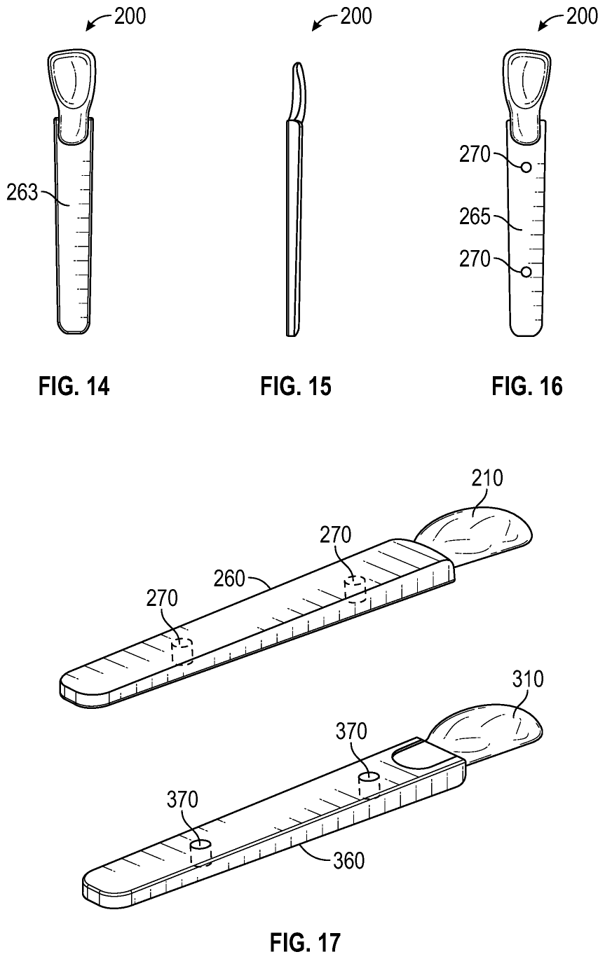

FIG. 14 depicts an upper surface 263 of a veneer handle

FIG. 15 depicts a side view of a veneer handle.

FIG. 16 depicts a lower surface of a veneer handle 265 with one or more magnets 270 disposed on or within the handle.

FIG. 17 depicts a veneer handle 260 in magnetic alignment with a stump handle 360. The veneer handle magnets 270 may be aligned with the stump handle magnets 370.

The disclosed embodiments may be used for dental labs and dentists using zirconia dioxide materials as well as Lithium Sliicate or Lithium Disilicate materials. These mainly fall in the category of full porcelain systems, as to which the need of identifying the stump shade is very important.

What is claimed is:

1. A system for replicating the chroma and opacity of dental work by use stump and veneer replicas disposed together by use of complementary curvilinear geometry, the system comprising:
a) a veneer (200) having an outward convex surface (210) and an inward concave surface (220) the veneer attached to a veneer handle (260) the veneer handle having an upper surface (263) and a lower surface (265) with the lower surface having one more veneer handle magnets (270);
b) a stump (300) having an outward convex surface (310) and an inward concave surface (320) the stump attached to a stump handle (365) the stump handle having a lower surface (365) and an upper surface (363) the upper surface comprising one or more stump handle magnets (370) wherein the one or more stump handle magnets have polarity complementary to the polarity to the one or more veneer handle magnets.

2. The system of claim 1 wherein the outward convex surface of the stump is complementary to the inward concave surface of the veneer.

3. The system of claim 1 wherein the upper surface of the veneer handle comprises indica of translucency (290).

4. The system of claim 1 wherein the upper surface of the veneer handle comprises indicia of veneer color (295).

5. The system of claim 1 wherein the lower surface of the stump handle comprises indicia of stump color (395).

6. The system of claim 1 wherein the stump has a distal edge (315) and the veneer has a distal edge (215) that extends over the distal edge of the stump when the veneer handle and stump handle are in magnetic connection.

7. The system of claim 1 further comprising a base (420) the base comprising a plurality of rack magnets (430) the rack magnets disposed to comport with the positions of the veneer handle magnets.

8. The system of claim 1 further comprising a base (420) the base comprising a plurality of rack magnets (430) the rack magnets disposed to comport with the positions of the stump handle magnets.

9. The system of claim 1 further comprising a (500) storage and presentation rack for low translucent veneers (500) comprising a plurality of magnets disposed to comport with the positions and polarity of the one or more veneer handle magnets.

10. The system of claim 1 further comprising a (540) storage and presentation rack for stumps comprising a plurality of magnets disposed to comport with the positions and polarity of the one or more stump handle magnets.

11. The system of claim 1 further comprising a storage and presentation rack for medium translucent veneers (510) comprising a plurality of magnets disposed to comport with the positions and polarity of the one or more veneer handle magnets.

12. The system of claim 1 further comprising a storage and presentation rack for low translucent veneers (520) comprising a plurality of magnets disposed to comport with the positions and polarity of the one or more veneer handle magnets.

13. The system of claim 1 further comprising a storage and presentation rack for high translucent veneers with bleach shading (530) comprising a plurality of magnets disposed to comport with the positions and polarity of the one or more veneer handle magnets.
